(19) United States
(12) Patent Application Publication
(10) Pub. No.: US 2025/0368285 A1
(43) Pub. Date: Dec. 4, 2025

(54) SYSTEM FOR PREDICTING TRAVEL OF HUMAN-POWERED VEHICLE AND SYSTEM FOR GENERATING MODEL FOR PREDICTING TRAVEL OF HUMAN-POWERED VEHICLE

(71) Applicant: YAMAHA HATSUDOKI KABUSHIKI KAISHA, Iwata-shi (JP)

(72) Inventors: Yutaka SARUWATARI, Shizuoka (JP); Shuhei FUJITA, Shizuoka (JP)

(21) Appl. No.: 19/223,808

(22) Filed: May 30, 2025

(30) Foreign Application Priority Data
May 31, 2024 (JP) 2024-089395

(51) Int. Cl. B62J 45/41; B60W 50/00; B62J 45/42; G06N 20/00

(52) U.S. Cl. CPC B62J 45/41; B60W 50/0097; B62J 45/42; G06N 20/00; B60W 2300/36

(57) ABSTRACT

A prediction system includes at least one computer configured or programmed to function as a detected-value acquisition unit to acquire currently detected values at a current point in time from a plurality of detectors on a human-powered vehicle and past values based on values detected by the plurality of detectors prior to the current point in time, and as a prediction unit to generate a predicted value relating to travel of the human-powered vehicle using a trained model built through machine learning and based on the currently detected values and past values from the plurality of detectors acquired by the detected-value acquisition unit.

### CROSS REFERENCE TO RELATED APPLICATIONS

This application is based upon and claims the benefit of priority to Japanese Patent Application No. 2024-089395, filed on May 31, 2024, the entire contents of which are hereby incorporated herein by reference.

### BACKGROUND OF THE INVENTION

### 1. Field of the Invention

The present invention relates to systems, methods and programs for predicting travel of a human-powered vehicle and generating models for predicting travel of a human-powered vehicle.

### 2. Description of the Related Art

One example of a human-powered vehicle is an electric motor-assisted bicycle. An electric motor-assisted bicycle controls a motor output based on values detected by various sensors such as a vehicle speed sensor and a pedaling-force sensor. If the motor output is controlled after detection of values by sensors, some delay occurs in the assistance by the motor.

JP 2023-047987 A discloses an electric bicycle capable of assisting the user based on his/her intention to accelerate. The control unit of this electric bicycle permits the motor to generate a driving force when the input torque is not less than a first threshold and the cadence is not less than a second threshold or the acceleration is not less than a third threshold.

JP 2023-048913 A discloses a control apparatus for a human-powered vehicle. The control unit of this control apparatus makes estimations about the road on which the vehicle is traveling depending on forward information including forward images captured by a capturing device. When the road on which the vehicle is traveling changes from a downhill slope to an uphill slope, the control unit controls the electric motor depending on at least one of a first distance between the human-powered vehicle and the location at which the road changes from the downhill slope to the uphill slope, a first angle of the downhill slope, a second angle of the uphill slope, and the difference between the first and second angles.

JP 2023-151357 A discloses a control apparatus for a human-powered vehicle. This control apparatus stores a first trained model that has been trained to provide output information relating to the control of devices based on input information relating to the travel of the human-powered vehicle. The control apparatus includes a control unit that controls devices in the human-powered vehicle based on control data based on output information from the first trained model, and a supplementary processing unit that supplements the first trained model with a second trained model. The second trained model is trained by input information in a human-powered vehicle where at least one of the human-powered vehicle and rider is different.

JP 2023-85936 A discloses a control apparatus for a human-powered vehicle that optimizes the criteria for control through automatic control depending on each rider. The control apparatus for a human-powered vehicle includes a first control unit that decides on control data for devices mounted on the human-powered vehicle using a predetermined control algorithm and based on input information relating to the travel of the human-powered vehicle and automatically controls the devices; an operation probability output model that, based on the input information, outputs the probability of the rider performing an intervention operation in response to the automatic control; and a second control unit that changes parameters for deciding on control data if the probability that has been output is not lower than a predetermined value.

In cases where the future travel of a human-powered vehicle is predicted simply using values from sensors in the vehicle, as is the case with the above-discussed conventional techniques, it may be difficult to have intentions of the rider reflected in the prediction. Further, the above conventional techniques require special sensors for prediction or a mechanism for learning, resulting in a complicated configuration.

### SUMMARY OF THE INVENTION

In view of this, example embodiments of the present application provide systems, programs, and methods that enable making a prediction relating to travel of a human-powered vehicle that reflects an intention of its rider using a simple configuration.

A system for predicting travel of a human-powered vehicle according to an example embodiment of the present invention includes at least one computer configured or programmed to function as a detected-value acquisition unit to acquire currently detected values at a current point in time from a plurality of detectors on the human-powered vehicle and past values based on values detected by the plurality of detectors prior to the current point in time, and as a prediction unit to generate a predicted value relating to the travel of the human-powered vehicle using a trained model built through machine learning and based on the currently detected values and the past values from the plurality of detectors acquired by the detected-value acquisition unit.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a functional block diagram illustrating an exemplary configuration of a system according to an example embodiment of the present invention.

FIG. 2 is a left side view of an exemplary construction of a bicycle.

FIG. 3 is a block diagram illustrating an exemplary mechanical and electrical connection configuration of components of the bicycle shown in FIG. 2.

FIG. 4 illustrates an exemplary flow chart of a process performed by the prediction system shown in FIG. 1, as well as exemplary data.

FIG. 5 is a functional block diagram illustrating an exemplary variation of the prediction system.

FIG. 6 illustrates a first exemplary implementation of a vehicle-load prediction model and a travel prediction model.

FIG. 7 illustrates a second exemplary implementation of a vehicle-load prediction model and a travel prediction model.

FIG. 8 illustrates an exemplary prediction process using the models shown in FIG. 6, as well as exemplary data.

FIG. 9 illustrates an exemplary prediction process using the models shown in FIG. 7, as well as exemplary data.

FIG. 10 illustrates an exemplary process for generating the vehicle-load prediction model and the travel prediction model shown in FIG. 6.

FIG. 11 illustrates an exemplary process for

generating the vehicle-load prediction model and the travel prediction model shown in FIG. 7.

FIG. 12 illustrates an exemplary travel prediction model that generates a predicted value representing vehicle speed.

FIG. 13 illustrates an exemplary travel prediction model that generates a predicted value representing a number of crank rotations.

FIG. 14 illustrates an exemplary travel prediction model that generates a predicted value representing pedaling force.

FIG. 15 illustrates an exemplary travel prediction model that generates a predicted value representing motor output.

FIG. 16 is a functional block diagram illustrating an exemplary configuration of a controller of the control system.

### DETAILED DESCRIPTION OF THE EXAMPLE EMBODIMENTS

A system for predicting travel of a human-powered vehicle according to an example embodiment of the present invention includes at least one computer configured or programmed to function as a detected-value acquisition unit to acquire currently detected values at a current point in time from a plurality of detectors on the human-powered vehicle and past values based on values detected by the plurality of detectors prior to the current point in time, and a prediction unit to generate a predicted value relating to the travel of the human-powered vehicle using a trained model built through machine learning and based on the currently detected values and the past values from the plurality of detectors acquired by the detected-value acquisition unit.

In the configuration above, a trained model is used to generate a predicted value relating to travel. The predicted value is generated based on currently detected values from a plurality of detectors on the human-powered vehicle and, in addition, past values based on values detected in the past. Thus, making a prediction using a trained model based on values detected at the current point in time and values detected in the past will allow the intention of the rider of the human-powered vehicle to be reflected in the predicted value. This will enable making a prediction relating to travel that reflects the intention of the rider of the human-powered vehicle using a simple configuration.

Each of the detectors of the human-powered vehicle may, for example, detect at least one of a physical quantity relating to the travel of the human-powered vehicle or a rider input. The plurality of detectors may include, for example, at least two of a vehicle speed sensor, a pedaling-force sensor, a crank rotation sensor, an acceleration sensor, a motor sensor, a steering-angle sensor, a seat height sensor, a seat pressure sensor, a gear-change sensor, a brake sensor, or a rider input device (e.g., a button, a switch, or a touch panel). The motor sensor may be a sensor that detects a motor output for pedaling assistance, for example.

Each of the past values from the plurality of detectors may be a value detected at at least one point in time prior to the current point in time, or may be a value calculated based on a group of values detected at a plurality of points of time prior to the current point in time.

The predicted value generated by the prediction unit may be a value indicative of a physical quantity relating to the travel of the human-powered vehicle. The predicted value may include, for example, a value of at least one of vehicle speed, pedaling force, the number of crank rotations, acceleration, motor output for pedaling assistance, handlebar steering angle, seat height, or gearshift in the human-powered vehicle. The trained model may be, for example, a model that receives, as input, currently detected values and past values from the plurality of detectors of the human-powered vehicle and provides, as output, a predicted value relating to the travel of the human-powered vehicle.

In the configuration above, the plurality of detectors may include at least two of a vehicle speed sensor, a pedaling-force sensor, a crank rotation sensor, an acceleration sensor, or a motor output sensor for pedaling assistance in the human-powered vehicle. The predicted value generated by the prediction unit may include a value indicative of at least one of vehicle speed, pedaling force, a number of crank rotations, acceleration, or motor output for pedaling assistance in the human-powered vehicle. This will enable making a prediction relating to travel that better reflects the intention of the rider.

In the configuration above, the detected-value acquisition unit may acquire, as the past values from the plurality of detectors, past values based on a group of values detected in a period of time prior to the current point in time. This will enable making a prediction relating to travel that even better reflects the intention of the rider.

For example, the past values from at least one of the plurality of detectors to be acquired by the detected-value acquisition unit may be past values based on a group of values detected in a plurality of different periods of time prior to the current point in time.

In the configuration above, the trained model may include a vehicle-load prediction model and a travel prediction model. The prediction unit may be configured or programmed to include a vehicle-load determination unit to determine a value indicative of a vehicle load on the human-powered vehicle using the vehicle-load prediction model and based on currently detected values and past values from at least two of the plurality of detectors, and a travel prediction unit to generate the predicted value using the travel prediction model and based on the value indicative of the vehicle load and the currently detected values and the past values from the plurality of detectors. This will generate an appropriate predicted value depending on vehicle load.

The vehicle load on the human-powered vehicle (i.e., vehicle) depends on the travel environment for, or the vehicle condition of, the human-powered vehicle. The value indicative of vehicle load may be a value indicative of a condition of vehicle load that depends on the travel environment or vehicle condition, for example. The term “vehicle load” could be replaced by “travel condition”. The value indicative of vehicle load may be, for example, a value indicative of the slope (i.e., upward, downward or flat), along the direction of travel of the road on which the vehicle is traveling. Also, in addition to the slope along the direction of travel of the road on which the vehicle is traveling, a further value indicative of vehicle load may be a value indicative of the vehicle load derived from at least one of the amount of load packed onto the vehicle, the wind received by the vehicle, or the air pressure in the tires of the vehicle. The value of vehicle load may be, for example, a value indicating one of a plurality of predetermined phases of vehicle load.

In the configuration above, the travel prediction model may be configured or programmed to include a plurality of load-specific travel prediction models corresponding to a plurality of vehicle load levels. The travel prediction unit may generate the predicted value using a load-specific travel prediction model corresponding to the value indicative of the vehicle load determined by the vehicle-load determination unit.

In the configuration above, the travel prediction model may be a trained model configured to receive, as input, the value indicative of the vehicle load and the currently detected values and the past values from the plurality of detectors and provide, as output, the predicted value relating to the travel of the human-powered vehicle.

The vehicle-load prediction model may be, for example, a model that provides, as output, a value indicative of vehicle load based on at least two of vehicle speed, pedaling force, the number of crank rotations, or motor output for pedaling assistance in the human-powered vehicle. This will enable more precise prediction of the vehicle load.

Example embodiments of the present invention also include a system for controlling a human-powered vehicle including the system for predicting the travel of a human-powered vehicle of any one of configurations above. The system for controlling a human-powered vehicle further includes a controller configured or programmed to control a device on the human-powered vehicle based on the predicted value generated by the prediction unit. This will enable controlling the device in a manner that reflects the intention of the rider of the human-powered vehicle using a simple configuration. Specifically, the control will better follow the intention of the rider. As a result, the ride feel for the rider will be improved.

In the configuration above, the device may be at least one of a motor to assist a rider in human-powered driving (i.e., operation to propel the human-powered vehicle, such as pedaling), a motor to assist the rider in steering, an actuator to adjust a position of a seat on which the rider sits, an electronic gearshift, or a display. The motor for assisting the rider in steering may be, for example, an electric power steering (EPS) system.

Example embodiments of the present invention also include a human-powered vehicle including a system for predicting the travel of a human-powered vehicle of any one of configurations above or the system for controlling a human-powered vehicle above.

A trained model according to an example embodiment of the present invention is a trained model built through machine learning. The trained model receives, as input, currently detected values at a current point in time from a plurality of detectors on the human-powered vehicle and past values based on values detected by the plurality of detectors prior to the current point in time, and provides, as output, a predicted value relating to travel of the human-powered vehicle. The use of this trained model will enable making a prediction relating to travel that reflects the intention of the rider of the human-powered vehicle using a simple configuration.

In the configuration above, the trained model may include a vehicle-load prediction model configured to receive, as input, currently detected values and past values from at least two of the plurality of detectors and provides, as output, a value indicative of a vehicle load on the human-powered vehicle, and a travel prediction model configured to receive, as input, the value indicative of the vehicle load output by the vehicle-load prediction model and the currently detected values and the past values from the plurality of detectors, and provide the predicted value as output.

The travel prediction model may include, for example, a model that performs the process of receiving, as input, a value indicative of vehicle load and currently detected values and past values from the plurality of detectors, and providing a predicted value as output. Alternatively, the travel prediction model may include a plurality of load-specific travel prediction models corresponding to a plurality of vehicle-load levels. In such implementations, the currently detected values and past values from the plurality of detectors are input to that one of the plurality of load-specific travel prediction models which corresponds to the input value indicative of vehicle load, and the predicted value is output by the load-specific travel prediction model.

A system for generating a model for predicting travel of a human-powered vehicle according to an example embodiment of the present invention includes a training-data acquisition unit configured or programmed to acquire, as training data, a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest; and a machine learning unit configured or programmed to generate, through machine learning using the training data, a trained model to provide, as output, a predicted value relating to future travel of the human-powered vehicle after the current point in time based on currently detected values at a current point in time and past values based on values detected prior to the current point in time from the plurality of detectors.

The above configuration will enable generating a trained model that enables making a prediction relating to travel that reflects the intention of the rider of the human-powered vehicle using a simple configuration.

In the configuration above, the training-data acquisition unit may be configured or programmed to acquire the plurality of datasets each further including a value indicative of the vehicle load on the human-powered vehicle. The machine learning unit may generate the trained model to provide the predicted value as output based on, in addition to the currently detected values for the current point in time and the past values from the plurality of detectors, the value indicative of the vehicle load. This will enable generating a trained model that enables appropriate predictions depending on the vehicle load.

The machine learning unit may be configured or programmed to generate a vehicle-load prediction model that receives, as input, currently detected values and past values from at least two of the plurality of detectors and provides, as output, a value indicative of the vehicle load on the human-powered vehicle, and a travel prediction model that receives, as input, the value indicative of vehicle load output by the vehicle-load prediction model as well as the currently detected values and past values from the plurality of detectors, and provides the predicted value as output.

The trained model is built through machine learning. The machine learning is performed by a computer using a learning algorithm. The machine learning may be, for example, learning with training data, learning without training data, or reinforcement learning.

The trained model may be, for example, data representing mathematical expressions for calculating a predicted value. Such a mathematical expression may be a mathematical expression including, as variables, the currently detected values and past values from the plurality of detectors. In implementations where the trained model is data representing mathematical expressions, parameters in the mathematical expressions or expression constructions may be decided upon through machine learning to generate a trained model.

In the system for predicting the travel of a human-powered vehicle of any one of configurations above or the system for controlling a human-powered vehicle above, the at least one computer may include a vehicle-mountable computer and a vehicle-mountable storage to be mounted on the human-powered vehicle. The vehicle-mountable computer may perform the functions of the detected-value acquisition unit and the prediction unit. The vehicle-mountable storage may store the trained model to be used for the functions of the prediction unit. This will implement the functions of the system for predicting the travel of a human-powered vehicle or the system for controlling a human-powered vehicle through edge computing by a vehicle-mountable computer and vehicle-mountable storage. In other words, the entire functions of the system for predicting the travel of a human-powered vehicle or the system for controlling a human-powered vehicle may be implemented by vehicle-mountable devices, without communicating with an external device other than the vehicle-mountable devices. Since no communication is necessary between the human-powered vehicle and the outside, a quick prediction or control functions will be possible. Further, prediction or control will be possible without depending on the communication environment.

A program for predicting travel of a human-powered vehicle according to an example embodiment of the present invention causes a computer to perform a detected-value acquisition process in which currently detected values at a current point in time from a plurality of detectors on the human-powered vehicle and past values based on values detected by the plurality of detectors prior to the current point in time are acquired, and a prediction process in which a predicted value relating to the travel of the human-powered vehicle is generated using a trained model built through machine learning and based on the currently detected values and the past values from the plurality of detectors acquired in the detected-value acquisition process.

A method of predicting travel of a human-powered vehicle according to an example embodiment of the present invention is performed by a computer. The method of predicting the travel of a human-powered vehicle includes acquiring detected-values in which currently detected values at a current point in time from a plurality of detectors on the human-powered vehicle and past values based on values detected by the plurality of detectors prior to the current point in time are acquired, and predicting a predicted value relating to the travel of the human-powered vehicle generated using a trained model built through machine learning and based on the currently detected values and the past values from the plurality of detectors acquired in the detected-value acquisitions step.

A program for generating a model for predicting travel of a human-powered vehicle according to an example embodiment of the present invention causes a computer to perform a training-data acquisition process in which a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest from the plurality of detectors are acquired as training data; and a machine learning process in which a trained model is generated through machine learning using the training data, the trained model configured to receive, as input, currently detected values at a current point in time from the plurality of detectors and past values based on values detected by the plurality of detectors prior to the current point in time, and provide, as output, a predicted value relating to future travel of the human-powered vehicle after the current point in time.

A method of generating a model for predicting travel of a human-powered vehicle according to an example embodiment of the present invention is performed by a computer. The method of generating a model for predicting the travel of a human-powered vehicle includes acquiring training-data acquisition in which a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest from the plurality of detectors are acquired as training data; and machine learning a trained model using the training data, the trained model being configured to receive, as input, currently detected values at a current point in time from the plurality of detectors and past values based on values detected by the plurality of detectors prior to the current point in time, and provide, as output, a predicted value relating to future travel of the human-powered vehicle after the current point in time.

Now, systems according to example embodiments of the present invention will be described with reference to the drawings. In the drawings, the same and corresponding elements are labeled with the same reference numerals, and their description will not be repeated. In the description provided below, the directions “front/forward” and “rear (ward)”, “left” and “right”, and “top/up (ward)” and “bottom/down (ward)” of a human-powered vehicle (by way of example, a bicycle) refer to such directions as perceived by a rider sitting on the saddle (i.e., seat 24) and gripping the handlebars 23. The directions “front/forward” and “rear (ward)”, “left” and “right”, and “top/up (ward)” and “bottom/down (ward)” of the human-powered vehicle are the same as the respective directions of the vehicle body, i.e., vehicle body frame, of the human-powered vehicle. Furthermore, the forward direction of the human-powered vehicle is aligned with the front-rear direction of the human-powered vehicle. The example embodiments described below are merely exemplary, and the present invention is not limited to the example embodiments described below.

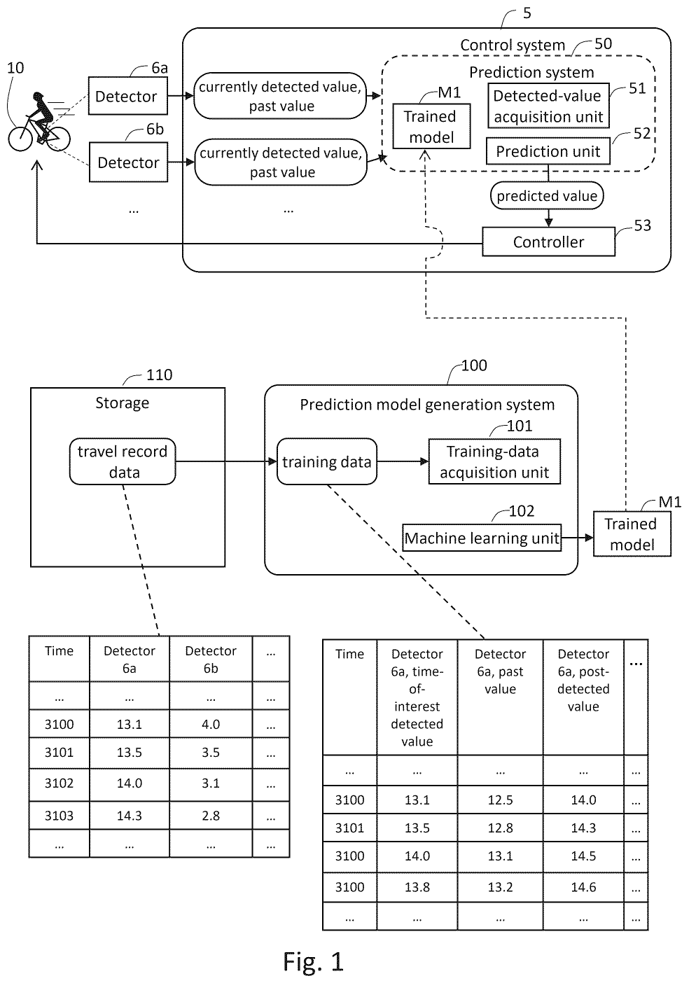

FIG. 1 is a functional block diagram illustrating an exemplary configuration of a system for predicting the travel of a human-powered vehicle (hereinafter simply referred to as “prediction system”), a system for controlling the human-powered vehicle (hereinafter simply referred to as “control system”), and a system for generating a model for predicting the travel of the human-powered vehicle (hereinafter simply referred to as “prediction model generation system”) according to example embodiments of the present invention. The prediction system 50 in FIG. 1 is provided within the control system 5. The control system 5 controls devices on the human-powered vehicle. In the present example embodiment, by way of example, the human-powered vehicle is a bicycle 10. The prediction system 50 generates a predicted value relating to the travel of the bicycle 10 based on detected values from a plurality of detectors 6a and 6b on the bicycle 10. Predicted values are generated using a trained model. The prediction model generation system 100 generates such a trained model.

The prediction system 50 includes a detected-value acquisition unit 51 and a prediction unit 52. The detected-value acquisition unit 51 acquires currently detected values and past values from a plurality of detectors 6a and 6b. A currently detected value is a value detected at a current point in time. A past value is a value based on a value detected prior to the current point in time. For example, the detected-value acquisition unit 51 may acquire currently detected values and past values from a storage that stores detected values from the various detectors in a time series. For each detector, the currently detected value to be acquired by the detected-value acquisition unit may be the newest detected value. The past value to be acquired by the detected-value acquisition unit may be a value detected prior to the currently detected value itself or a value calculated based on a group of detected values in the past.

The detected-value acquisition unit 51 may acquire a past value calculated based on a group of detected values in the past and stored in the storage, or may calculate a past value based on a group of detected values in the past stored in the storage. For one detector, one or more past values may be acquired by the detected-value acquisition unit. The past value calculated based on the group of detected values in the past may be, for example, a statistic reference, a rate of change, or a value indicative of other characteristics of the group of detected values. The statistic reference of past values may be, for example, a representative value such as an average, a median, or a mode, or a value indicative of a dispersion such as a range, a variance, or a standard deviation. The past value may also be a value calculated using a group of values detected in a predetermined period of time prior to the current point in time, for example.

The prediction unit 52 generates a predicted value relating to the travel of the bicycle 10 based on the currently detected values and past values from the plurality of detectors 6a and 6b. The prediction unit 52 uses the trained model to generate a predicted value. The trained model may be, for example, a model that calculates a predicted value using the currently detected values and past values from the plurality of detectors 6a and 6b. Parameters for a model used to calculate a predicted value is decided upon through machine learning to build a trained model.

The control system 5 includes a controller 53. The controller 53 is configured or programmed to control devices on the bicycle 10 based on the predicted value generated by the prediction unit 52. The controller 53 may decide upon a control value using the predicted value and supply the devices with the control value.

The prediction model generation system 100 includes a training-data acquisition unit 101 and a machine learning unit 102. The training-data acquisition unit 101 acquires a plurality of datasets as training data. Each dataset includes time-of-interest detected values, past values and post-detected values from the plurality of detectors on the bicycle 10. A time-of-interest detected value is a value detected at a point in time of interest. A past value is a value based on a value detected prior to the time point of interest. A post-detected value is a value detected at a point in time after the time point of interest.

In the implementation of FIG. 1, the training data is data based on travel record data. The travel record data is time-series data with detected values from the plurality of detectors 6a and 6b. Thus, the training data may be obtained based on data including values detected at various points of time from the various detectors. In the implementations of FIG. 1, a dataset including time-of-interest detected values for various points of time representing time points of interest, past values represented by statistics generated from a group of values detected in a predetermined period of time prior to the time point of interest, and post-detected values represented by values detected a predetermined period of time after the time point of interest constitutes training data.

The training-data acquisition unit 101 may generate training data based on travel record data stored in the storage 110. Alternatively, the training-data acquisition unit 101 may acquire training data by reading training data stored in the storage 110. It will be understood that a bicycle that supplies detected values for training data to be used by the prediction model generation system may not be exactly the same as a bicycle that supplies detected values to be used for the prediction process of the prediction system. For example, it is preferable that the configuration of a plurality of detectors included in a human-powered vehicle that supplies detected values for training data is the same as the configuration of a plurality of detectors included in a human-powered vehicle that supplies detected values used by the prediction system. By way of example, the configuration of a human-powered vehicle that supplies detected values for training data may be the same as the configuration of a human-powered vehicle that supplies detected values used by the prediction system.

The machine learning unit 102 generates a trained model using the training data. The trained model is a model that generates a predicted value using currently detected values and past values from the plurality of detectors 6a and 6b. The machine learning unit 102 is able to perform machine learning using the time-of-interest detected values and past values from the various detectors in a dataset of the training data as data to be input to the model and the post-detected values as labels (i.e., correct-answer data). During machine learning, for example, the input data and labels are used to adjust parameters for the model. This results in a trained model that generates a predicted value based on currently detected values and past values from the various detectors.

During the machine learning by the machine learning unit 102, for example, such parameters in a mathematical expression or such an expression construction may be decided upon that a value calculated by assigning, to the variables in the mathematical expression, a time-of-interest detected value for a time point of interest and a past value from each of the plurality of detectors contained in each dataset of the training data is close to the associated post-detected value contained in that dataset. During machine learning, parameters in a mathematical expression may be decided upon using multiple regression analysis or decision tree analysis, for example. The trained model is not limited to data representing a mathematical expression. The trained model may be a model using a neural network (NN), for example. The machine learning may be deep learning.

Each of the prediction system, control system, and prediction model generation system is implemented by one or more computers. In other words, the various functional units of the prediction system, control system and prediction model generation system may be implemented by a computer/computers executing a program. Each computer may include, for example, a CPU, an MPU (micro-processing unit), an MCU (micro-controller unit), a PLD (programable logic device), an FPGA (field-programmable gate array), an ASIC (application-specific integrated circuit) or other ICs. Example embodiments of the present invention include a program that performs the functions of the prediction system, a control system and prediction model generation system, and a non-transitory storage medium storing such a program.

The prediction system and control system may be implemented by, for example, a vehicle-mountable computer mounted on the human-powered vehicle (i.e., bicycle 10). In such implementations, the trained model may be stored on a vehicle-mountable storage mounted on the human-powered vehicle. The vehicle-mountable computer may be a computer included in a device on the human-powered vehicle (i.e., vehicle-mountable device). The vehicle-mountable storage may be a data storage included in a vehicle-mountable device (e.g., storage or memory). A vehicle-mountable device including a vehicle-mountable computer or a vehicle-mountable storage may be, for example, a drive unit 40, a UI unit 70 or a display device 71 in the bicycle 10, discussed further below, or any other control device. It will be understood that vehicle-mountable devices include devices detachable from the human-powered vehicle, such as a cycle computer mounted on the human-powered vehicle and connected via a cable or wirelessly to the detectors of the human-powered vehicle (i.e., cycle meter) or a smartphone. A computer or storage included in such a detachable device may constitute a vehicle-mountable computer or vehicle-mountable storage.

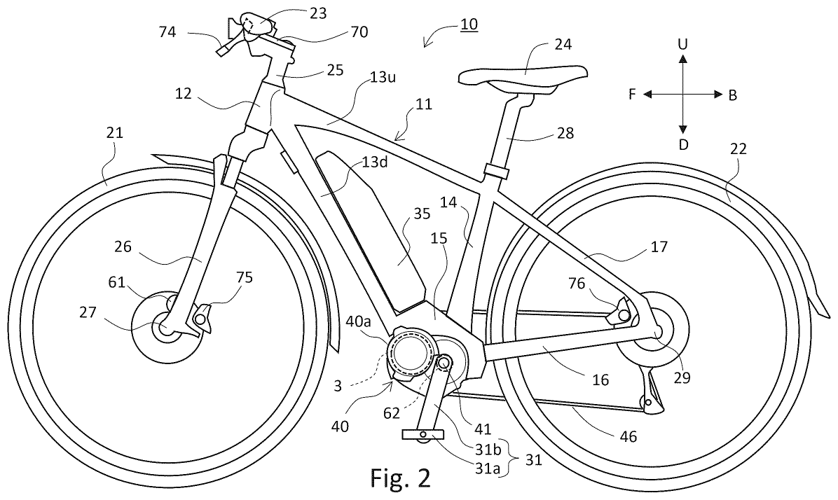

FIG. 2 is a left side view of an exemplary construction of the bicycle 10. The characters F, B, U, and D in FIG. 2 indicate forward, rearward, upward, and downward, respectively. By way of example, the bicycle 10 is an electric motor-assisted bicycle. The bicycle 10 includes a plurality of wheels 21 and 22, a vehicle body frame 11, a motor 3, a crankshaft 41, and pedals 31. The wheels 21 and 22, the crankshaft 41 and the pedals 31 are rotatably supported on the vehicle body frame 11. The bicycle 10 further includes a transmission mechanism that transmits rotation of the motor 3 to at least one of the wheels 21 and 22 and a transmission mechanism that transmits a pedaling force applied to the pedals 31 and crankshaft 41 to at least one of the wheels 21 and 22. At least one of the wheels 21 and 22 is driven by at least one of the pedaling force applied to the pedals 31 or the driving force generated by the motor 3.

As shown in FIG. 2, the vehicle body frame 11 extends in the front-rear direction. The vehicle body frame 11 includes a head pipe 12, an upper frame portion 13u, a down frame portion 13d, a seat frame portion 14, a pair of chain stays 16, and a pair of seat stays 17. The head pipe 12 is located toward the front with respect to the bicycle 10. The front ends of the down and upper frame portions 13d and 13u are connected to the head pipe 12. The down and upper frame portions 13d and 13u extend in the front-rear direction. The down and upper frame portions 13d and 13u extend obliquely downward. The upper frame portion 13u is located higher than the down frame portion 13d. The rear end of the upper frame portion 13u is connected to the seat frame portion 14. The rear end of the down frame portion 13d is connected to a bracket 15. The lower end of the seat frame portion 14 is connected to the bracket 15. The seat frame portion 14 extends upward and obliquely rearward from the bracket 15. It will be understood that the vehicle body frame 11 may not include an upper frame portion 13u.

A handle stem (i.e., steering column) 25 is inserted into the head pipe 12 so as to be rotatable. The handlebars 23 are fixed to the upper end of the handle stem 25. A front fork 26 is fixed to the lower end of the handle stem 25. The front wheel 21 is rotatably supported on the lower end of the front fork 26 by an axle 27.

A grip is attached to each of the left and right ends of the handlebars 23. A left brake lever 74 is attached to a location on the handlebars 23 toward the left, whereas a right brake lever 74 is attached to a location on the handlebars 23 toward the right. The left brake lever 74 enables operating a brake 76 for the rear wheel 22. The right brake lever 74 enables operating a brake 75 for the front wheel 21.

A seat pipe 28 is inserted into the cylindrical seat frame portion 14. A seat (i.e., saddle) 24 is provided on the upper end of the seat pipe 28. Thus, the vehicle body frame 11 rotatably supports the handle stem 25 at its front, and rotatably supports the rear wheel 22 at its rear. Further, the seat 24 and a drive unit 40 are attached to the vehicle body frame 11.

The pair of chain stays 16 are connected to the rear end of the bracket 15. The chain stays 16 are positioned to sandwich the rear wheel 22 from the left and right. One end of each of the seat stays 17 is connected to the rear end of the associated one of the chain stays 16. The seat stays 17 are positioned to sandwich the rear wheel 22 from the left and right. The other end of each of the seat stays 17 is connected to a location on the seat frame portion 14 toward its top. The rear wheel 22 is rotatably supported on the rear ends of the chain stays 16 by an axle 29.

A vehicle speed sensor (i.e., speed sensor) 61 that detects rotation of the front wheel 21 is provided on the front fork 26. The vehicle speed sensor 61 includes, for example, a detected element that rotates together with the front wheel 21 (i.e., a wheel), and a detecting element fixed to the vehicle body frame 11 to detect rotation of the detected element. The detecting element detects the detected element in a mechanical, magnetic, or optical manner. The vehicle speed sensor 61 may detect rotation of a rotating body other than the front wheel 21 that rotates as the bicycle 10 travels forward, such as the rear wheel 22, motor 3, crankshaft 41, transmission gear, or chain.

The drive unit 40 is attached to the lower edge of the bracket 15 by fasteners (not shown). The drive unit 40 includes a housing 40a defining the exterior of the drive unit 40. The motor 3 is contained in the housing 40a. The crankshaft 41 extends through the housing 40a in the left-right direction. The crankshaft 41 is rotatably supported on the housing 40a by a plurality of bearings.

A pedaling-force sensor 62 is provided around the crankshaft 41 to detect a pedaling force applied by the rider. The pedaling-force sensor 62 detects a torque that rotates the crankshaft 41 about its axis. The pedaling-force sensor 62 may be, for example, a non-contact torque sensor such as a magnetostrictive sensor, or a contact torque sensor such as an elastic-body variable detection-type sensor. A magnetostrictive torque sensor includes a magnetostrictive member that produces magnetostrictive effects and that receives a rotational force of the crankshaft, and a detection coil that detects a change in magnetic permeability caused by a force from the magnetostrictive member.

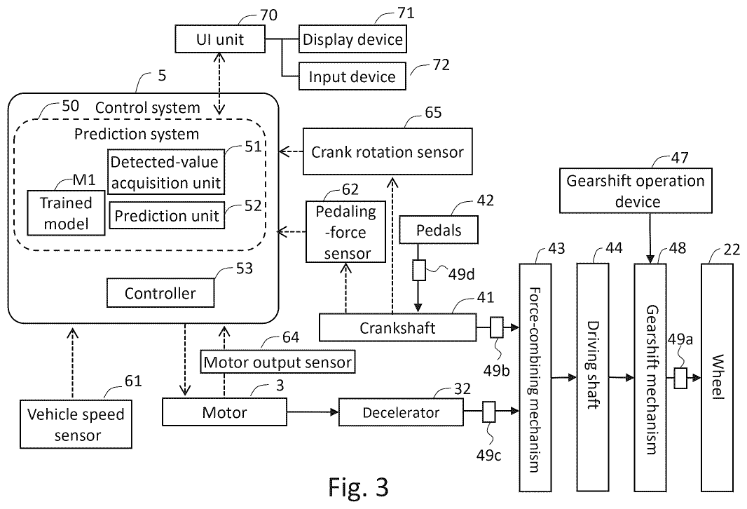

Crank arms 31b are attached to the respective ends of the crankshaft 41. Pedal steps 31a are attached to the distal ends of the respective crank arms 31b. The pedals 31 include the crank arms 31b and pedal steps 31a. The crankshaft 41 is rotated by the rider pressing the pedals 31. Although not shown, the bicycle 10 is provided with a driving sprocket that rotates together with the crankshaft 41 and a driven sprocket that rotates together with the rear wheel 22. A chain 46 is wound around the driving and driven sprockets to connect them. It will be understood that the chain 46 may be replaced by a belt, a shaft or the like. A one-way clutch 49a (see FIG. 3) is provided in the path of transmission of rotation from the driven sprocket to the rear wheel 22. The one-way clutch 49a transmits forward rotation (i.e., normal rotation), and does not transmit rearward rotation (i.e., reverse rotation).

A transmission mechanism (not shown) is provided within the drive unit 40 to transmit the rotation of the motor 3 to the driving sprocket (or chain 46). The transmission mechanism includes, for example, a decelerator (i.e., a set of reduction gears) 32 (see FIG. 3). The decelerator 32 reduces the rotational speed of the motor before transmission to the driving sprocket. Further, the transmission mechanism includes a synthesizing mechanism that synthesizes the rotation of the crankshaft 41 and the rotation of the motor 3 before transmission to the driving sprocket. The synthesizing mechanism includes a cylindrical member, for example. The crankshaft 41 is located within the cylindrical member. The driving sprocket is attached to the synthesizing mechanism. The synthesizing mechanism rotates about the same axis of rotation as the crankshaft 41 and driving sprocket. One-way clutches 49b and 49c (see FIG. 3) may be provided in the path of transmission of rotation from the crankshaft 41 to the synthesizing mechanism and the path of transmission of rotation from the motor 3 to the synthesizing mechanism, respectively. The rotational force transmitted from the motor 3 to the driving sprocket via the transmission mechanism provides the driving force for the wheel (i.e., rear wheel 22).

A battery unit 35 is positioned on the vehicle body frame 11. The battery unit 35 supplies the motor 3 of the drive unit 40 with electric power. The battery unit 35 includes a battery and a battery controller, not shown. The battery is a chargeable battery that can be charged and discharged. The battery controller controls the charging and discharging of the battery and, at the same time, monitors output current, remaining capacity, and other information about the battery.

The handlebars 23 are provided with the user interface unit (i.e., UI unit) 70 that receives various operations by the rider. The UI unit 70 includes, for example, an input device 72, such as a set of buttons or a touch screen, that receives user operations. The UI unit 70 may also include a display device (i.e., display) 72. In such implementations, the display device 71 and input device 72 may together constitute a touch panel. The display device 71 shows various information relating to the bicycle 10.

FIG. 3 is a block diagram illustrating an exemplary mechanical and electrical connection configuration of components of the bicycle 10 shown in FIG. 2. In the implementation shown in FIG. 3, rotation of the pedals 31 is transmitted to a force-combining mechanism 43 via the one-way clutch 49d. Rotation of the motor 3 is transmitted to the force-combining mechanism 45 via the decelerator 32 and the one-way clutch 49c. The force-combining mechanism 43 includes, for example, the above-mentioned synthesizing mechanism, driving sprocket, chain 46, and driven sprocket. Within the force-combining mechanism 43, a driving force is transmitted through the synthesizing mechanism, driving sprocket, chain 46, and driven sprocket in this order. Rotation of the driven sprocket is transmitted to the rear wheel 22 via a driving shaft 44, a gearshift mechanism 48, and the one-way clutch 49a.

The gearshift mechanism 48 changes the gear ratio in response to an operation of a gearshift operation device 47 by the rider. The gearshift operation device 47 may be mounted on the handlebars 23 (FIG. 1), for example. In this implementation, the gearshift mechanism 48 is an internal transmission-ratio changing mechanism located between the driving shaft 44 and rear wheel 22. Alternatively, the gearshift mechanism 48 may be an external transmission-ratio changing mechanism. If the gearshift mechanism 48 is an external transmission-ratio changing mechanism, the driven sprocket may be a multi-gear sprocket. In such implementations, the multi-gear sprocket, around which the chain 46 is wound, enables switching in response to a rider operation of the gearshift operation device 47.

The pedaling force generated by the rider pressing the pedals 31 rotates the crankshaft 41 in the forward direction. The rotation of the crankshaft 41 is transmitted, via the transmission mechanism, to the rear wheel 22. Thus, the rotational force output by the motor 3 is transmitted as a driving force that rotates the rear wheel 22 in the forward direction. If the pedaling force applied by the rider and the rotational force output by the motor 3 are transmitted to the crankshaft simultaneously, the rotational force output by the motor 3 is added, as assistance, to the pedaling force applied by the rider. In a variation, the rotational force output by the motor 3 may be transmitted to the front wheel 21. In other words, the transmission mechanism may be constructed such that the rotation output by the motor is transmitted to a wheel different from the wheel to which the rotation of the crankshaft 41 is transmitted. In such implementations, no synthesizing mechanism that would synthesize the pedaling force and the output of the motor is necessary. The rotational force generated by operation of the motor 3 may rotate the crankshaft 41 in the forward direction.

In the implementation of FIG. 3, the bicycle 10 includes the control system 5. The control system includes the prediction system 50. For example, a computer mounted on a circuit board within the housing 40a of the drive unit 40 may constitute the control system 5. The control system 5 (i.e., prediction system 50) is electrically connected to the vehicle speed sensor 61, pedaling-force sensor 62, crank rotation sensor 65, motor 3, motor output sensor 64, and UI unit 70. These connections may use cables, or may be wireless.

The crank rotation sensor 65 detects rotation of the crankshaft 41. The crank rotation sensor 65 may include, for example, a detected element that rotates together with the crankshaft 41, and a detecting element fixed to the vehicle body frame 11 to detect rotation of the detected element. The detecting element is able to detect the detected element in a mechanical, optical, or magnetic manner.

The motor output sensor 64 detects output of the motor 3. The motor output detected by the motor output sensor 64 may be at least one of the voltage, current, rotational speed (i.e., number of rotations), or torque relating to the motor 3. The motor output sensor 64 may detect the rotational speed (i.e., number of rotations) or torque of the motor based on the electric current, voltage and/or other electric signals relating to the motor 3. The motor output sensor 64 may be a voltage sensor or an electric current sensor, for example.

The transmission mechanism for the driving force generated by the motor 3 is not limited to the above-described exemplary implementation. For example, the drive unit 40 may include an output shaft that extends outwardly from within the housing 40a in the left-right direction. In such implementations, the rotation of the motor 3 is transmitted to the output shaft via the transmission mechanism. Outside the housing 40a, an auxiliary sprocket is attached to the output shaft. The chain 46 is wound around the auxiliary sprocket. The rotational force generated by operation of the motor 3 rotates the auxiliary sprocket and, via the chain 46, rotates the rear wheel 22 in the forward direction.

In the implementation of FIG. 2, the motor 3 is contained in the drive unit 40 attached to the vehicle body frame 11. Alternatively, the motor may be positioned on the hub of a wheel (at least one of the front or rear wheel 21 or 22) of the bicycle 10. In such implementations, the motor may be an in-wheel motor incorporated in the hub (i.e., hub motor). The hub motor may include, for example, a rotor and a stator. The axis of rotation of the rotor may be the same as the axis of the wheel 27, 29. The hub may be provided with a gear that transmits the rotation of the hub motor to the wheel (i.e., front or rear wheel 21 or 22). The gear may be a planetary gear, for example. Further, a one-way clutch may be provided in the path of transmission of rotation between the hub motor and wheel (i.e., front or rear wheel 21 or 22).

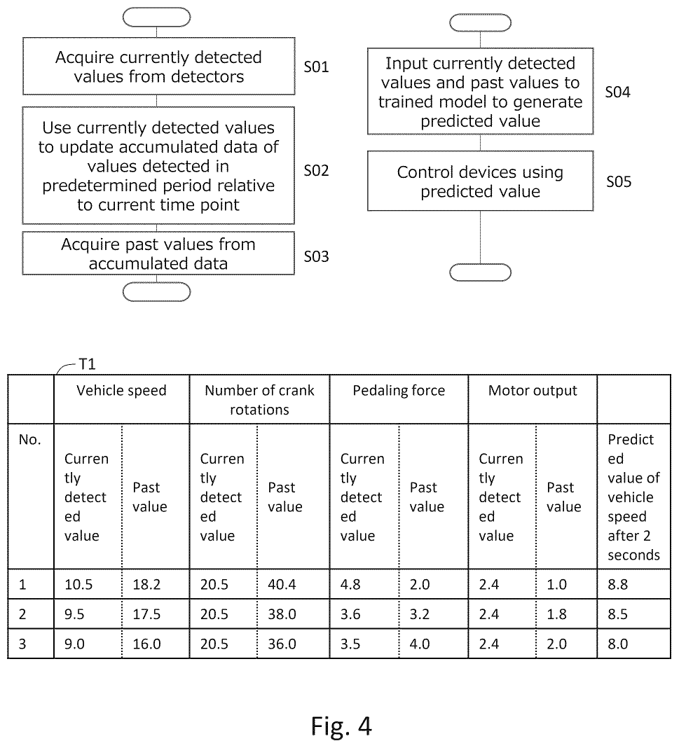

FIG. 4 illustrates an exemplary flow chart of a process performed by the prediction system 50 shown in FIG. 1, as well as exemplary data. In the implementation of FIG. 4, the detected-value acquisition unit 51 of the prediction system 50 acquires currently detected values for the current point in time, i.e., newest detected values, from the plurality of detectors 6a and 6b (S01). The following description illustrates one exemplary implementation where the plurality of detectors 6a and 6b include a vehicle speed sensor 61, a pedaling-force sensor 62, a crank rotation sensor 65 and a motor output sensor 64.

The detected-value acquisition unit 51 uses the currently detected values from the various detectors to update accumulated data of values detected in a predetermined period of time relative to a current point in time from the various detectors (S02). For example, data of a group of accumulated values that had been detected in a period from a point in time a predetermined period of time prior to the time at which currently detected values were detected (i.e., current point in time) until the current point in time is updated using the currently detected values. By way of example, the accumulated data is updated such that the accumulated data is a group of values detected in the latest (i.e., newest) period of 1000 ms. The accumulated data is stored, for example, in a storage (e.g., memory) accessible for the computer including the prediction system 50. The predetermined period of time relative to a current point in time covered by the accumulated data may be a plurality of different periods of time. For example, the accumulated data stored may be values detected in a period from a point in time 500 ms prior to a current point in time until the current point in time and a period of time from a point in time 1500 ms prior to the current point in time until a point in time 500 ms prior to the current point in time.

The detected-value acquisition unit 51 acquires past values based on the accumulated data that has been updated (S03). For example, the past values acquired may be values calculated based on a group of values detected in a predetermined period of time relative to the current point in time contained in the accumulated data. By way of example, a past value acquired is the average of values detected from a point in time 1000 ms prior to the current point in time until the current point in time. The average may be a simple average or may be a weighted moving average.

The prediction unit 52 inputs, to the trained model M1, the currently detected values and past values from the plurality of detectors 6a and 6b. The trained model outputs a predicted value depending on the currently detected values and past values (S04). A predicted value is thus generated. The controller 53 uses the predicted value generated at step S04 to control devices on the bicycle 10 (S05).

Table T1 in FIG. 4 illustrates one exemplary set of currently detected values and past values input to the trained model M1 and predicted values output in response. In the case of Table T1, combinations of currently detected and past values of vehicle speed, the number of crank rotations, pedaling force and motor output are input to the trained model M1. In response to each of these combinations of values, the trained model M1 outputs a vehicle speed after two seconds as a predicted value.

In Table T1, each of row Nos. 1 to 3 shows a set of values input to the trained model at one point in time during the travel of the human-powered vehicle as well as the predicted value that is output. The data of each of row Nos. 1 to 3 relates to a different point in time. In this implementation, the process of generating a predicted value using currently detected values and past values at one given time does not use currently detected values and past values for other points of time.

The prediction model generation system 100 is able to generate a trained model that receives, as input, and provides, as output, the data shown in Table TI in FIG. 4. In such an implementation, each dataset of the training data contains time-of-interest detected values and past values of vehicle speed, the number of crank rotations, pedaling force and motor output, and a value of vehicle speed two seconds after the time point of interest. A past value may be the average of a group of values detected in a predetermined period of time prior to the point in time of interest, for example.

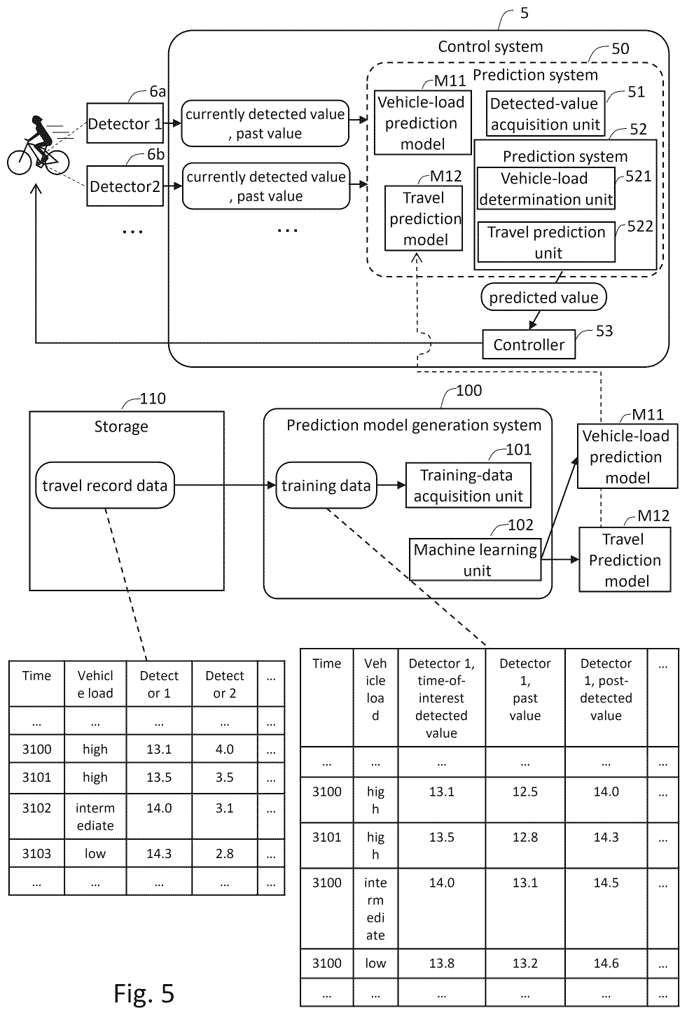

FIG. 5 is a functional block diagram illustrating an exemplary variation of the prediction system. In the implementation of FIG. 5, the prediction unit 52 of the prediction system 50 includes a vehicle-load determination unit 521 and a travel prediction unit 522. The trained model includes a vehicle-load prediction model M11 and a travel prediction model M12. The vehicle-load determination unit 521 determines the value indicative of the vehicle load on the bicycle 10 based on currently detected values and past values from the plurality of detectors 6a and 6b. This determination uses the vehicle-load prediction model M11. The travel prediction unit 522 generates a predicted value based on the value indicative of vehicle load and the currently detected values and past values from the plurality of detectors 6a and 6b. The generation of a predicted value uses the travel prediction model M12.

In the implementation shown in FIG. 5, the trained models generated by the prediction model generation system 100 are the vehicle-load prediction model M11 and a travel prediction model M12. A dataset of training data contains time-of-interest detected values, past values and post-detected values from the plurality of detectors 6a and 6b and, in addition, a value indicative of vehicle load at the time point of interest. The machine learning unit 102 performs machine learning by providing, as input data, the time-of-interest detected values and past values from the various detectors in the datasets to a model and using the values indicative of vehicle load as labels (i.e., correct-answer data) to generate a vehicle-load prediction model M11. Further, the machine learning unit 102 performs machine learning by providing, as input data, the time-of-interest detected values and past values from the various detectors in the datasets, or data including these values and, in addition, the values indicative of vehicle load to a model, and using post-detected values as labels (i.e., correct-answer data) to generate a travel prediction model M12.

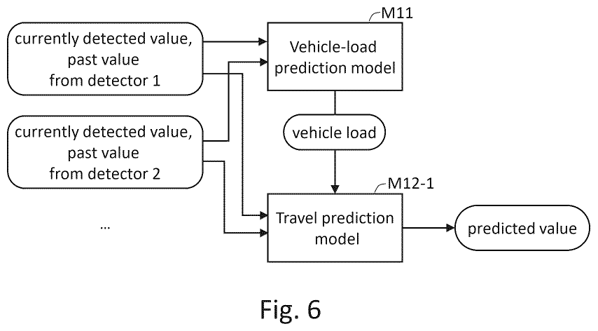

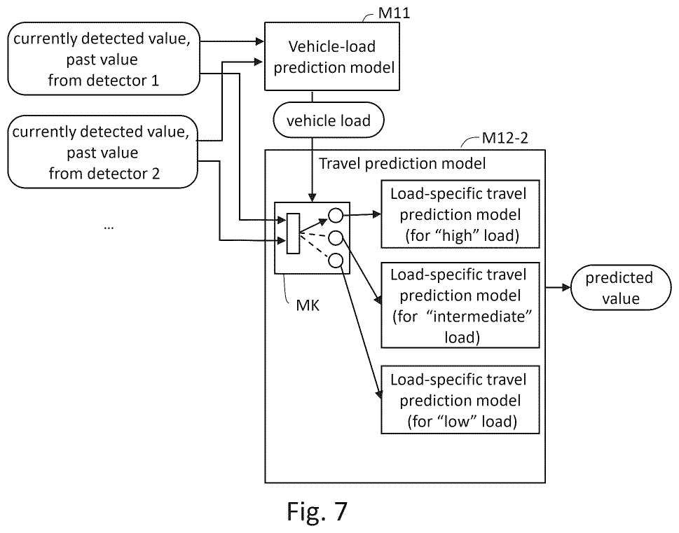

FIG. 6 illustrates a first exemplary implementation of the vehicle-load prediction model M11 and travel prediction model M12. FIG. 7 illustrates a second exemplary implementation of these models. In both implementations of FIGS. 6 and 7, the vehicle-load prediction model M11 receives, as input, currently detected values and past values from a plurality of detectors and provides a vehicle load as output. The travel prediction model M12 receives, as input, the currently detected values and past values from the plurality of detectors and, in addition, the value indicative of vehicle load, and provides a predicted value as output.

In the implementation of FIG. 6, the travel prediction model M12-1 includes one model that performs a process that includes receiving, as input, one value indicative of vehicle load as well as currently detected values and past values from the plurality of detectors; and providing a predicted value as output. In contrast, in the implementation of FIG. 7, the travel prediction model M12-2 includes a plurality of load-specific travel prediction models corresponding to a plurality of vehicle load levels. Further, the travel prediction model M12-2 includes a switching unit MK that switches among the load-specific travel prediction models to perform the prediction process depending on the value indicative of the vehicle load input. In the implementation of FIG. 7, the travel prediction model M12-2 includes load-specific travel prediction models corresponding to three phases, i.e., high, intermediate and low vehicle load levels. The vehicle load levels are not limited to three phases, and there may be two phases or four or more phases. The load-specific travel prediction model for the level corresponding to the vehicle load that has been input to the travel prediction model M12-2 receives, as input, currently detected values and past values from the plurality of detectors. This load-specific travel prediction model generates a predicted value.

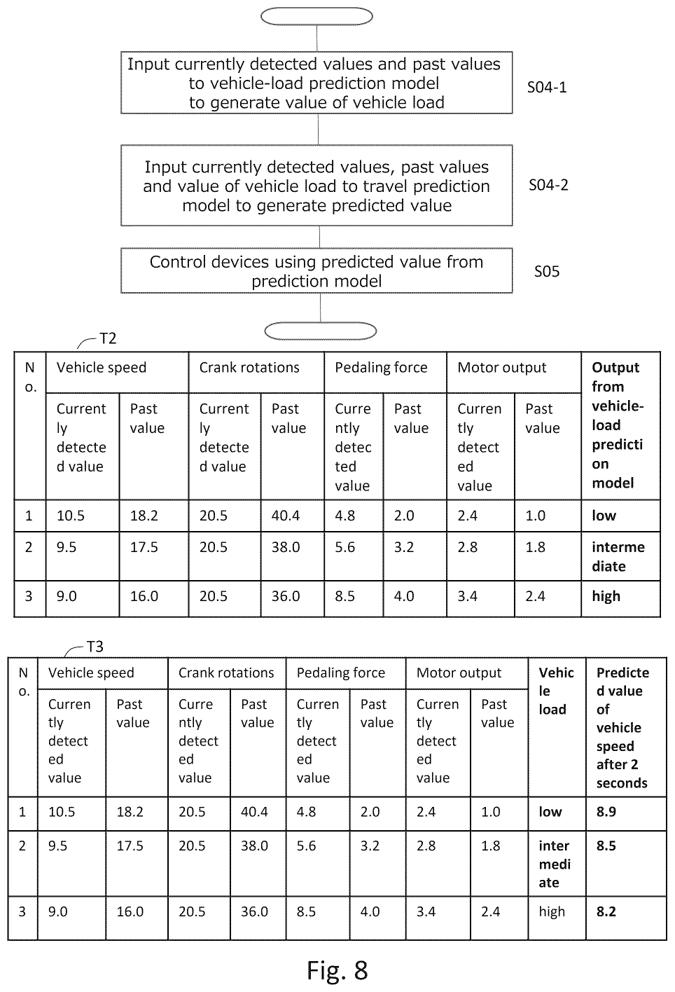

FIG. 8 illustrates an exemplary prediction process using the models shown in FIG. 6, as well as exemplary data. In the implementation of FIG. 8, the vehicle-load determination unit 521 inputs currently detected values and past values from the plurality of detectors 6a and 6b to the vehicle-load prediction model M11, and causes the vehicle-load prediction model M11 to generate a value indicative of vehicle load (S04-1). The travel prediction unit 522 inputs, to the travel prediction model M12-1, the value of vehicle load determined at step S04-1 as well as the currently detected values and past values from the plurality of detectors 6a and 6b to cause the travel prediction model M12-1 to generate a predicted value (S04-2).

Table T2 in FIG. 8 shows an exemplary set of data input to, and data output from, the vehicle-load prediction model M11. In this case, combinations of currently detected and past values of vehicle speed, the number of crank rotations, pedaling force and motor output are input to the vehicle-load prediction model M11. In response to each of these combinations of values, the vehicle-load prediction model M11 outputs a value indicative of vehicle load as a predicted value.

Table T3 in FIG. 8 shows exemplary data input to and data output from the travel prediction model M12-1. In this case, combinations of currently detected and past values of vehicle speed, the number of crank rotations, pedaling force and motor output as well as values indicative of vehicle load are input to the travel prediction model M12-1. In response to each of these combinations of values, the travel prediction model M12-1 outputs a value indicative of a vehicle speed after two seconds as a predicted value.

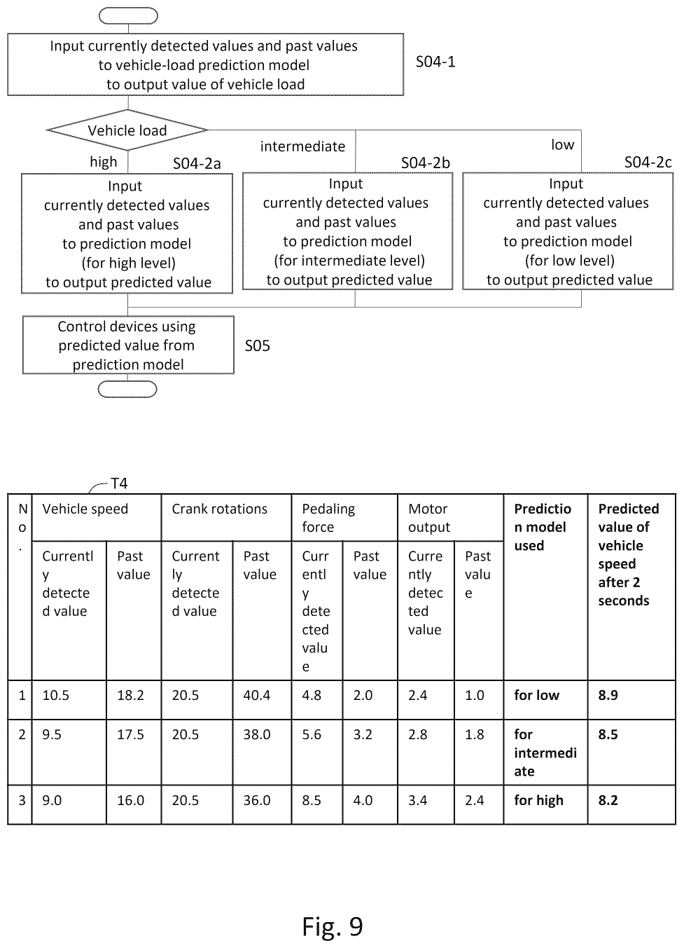

FIG. 9 illustrates an exemplary prediction process using the models shown in FIG. 7, as well as exemplary data. In the implementation of FIG. 9, the process for generating a value of vehicle load at step S04-1 may be the same as for step S04-1 in FIG. 8. The travel prediction model M12-2 inputs currently detected values and past values from the plurality of detectors 6a and 6b to the load-specific travel prediction model that corresponds to the vehicle load determined at step S04-1, and causes that load-specific travel prediction model to generate a predicted value (S04-2a to 2c). In this case, if the vehicle load level is high, the currently detected values and past values are input to the high-level load-specific travel prediction model, and the high-level load-specific travel prediction model generates a predicted value. Similarly, if the vehicle load level is intermediate, the intermediate-level load-specific travel prediction model generates a predicted value. If the vehicle load level is low, the low-level load-specific travel prediction model generates a predicted value.

Table T4 in FIG. 9 shows an exemplary data input to and data output from the travel prediction model M12-2 as well as exemplary load-specific travel prediction models that perform the prediction process. In this case, combinations of currently detected and past values of vehicle speed, the number of crank rotations, pedaling force and motor output are input to the load-specific travel prediction model corresponding to the vehicle load level. In response to each of these combinations of values, that load-specific travel prediction model outputs a vehicle speed after two seconds as a predicted value.

In implementations examples shown in FIGS. 8 and 9, the combination of detectors that supply data to be input to the vehicle-load prediction model M11 is the same as the combination of detectors that supply data to be input to the travel prediction model M12. These combinations may be different from each other. For example, from the detectors that supply data to be input to the travel prediction model M12 (i.e., vehicle speed sensor, pedaling-force sensor, crank rotation sensor and motor output sensor), only one or some detectors (e.g., vehicle speed sensor and pedaling-force sensor) may be detectors that also supply data to be input to the vehicle-load prediction model M11. Alternatively, the detectors that supply data to be input to the vehicle-load prediction model M11 may include a detector different from the detectors that supply data to be input to the travel prediction model M12.

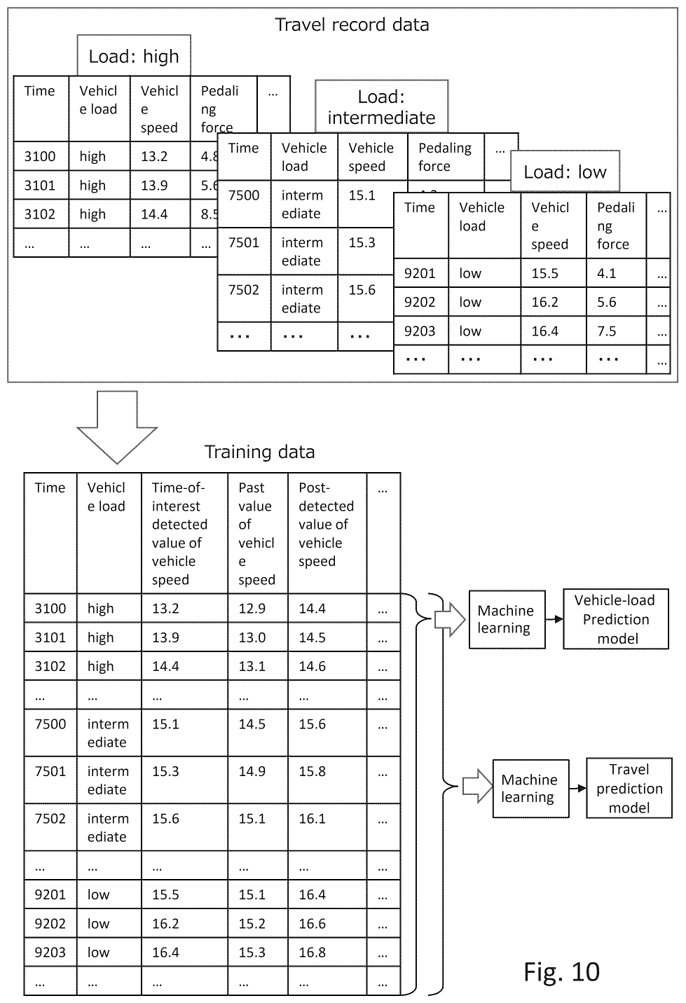

FIG. 10 illustrates an exemplary process for generating the vehicle-load prediction model M11 and travel prediction model M12-1 shown in FIG. 6. In the implementation of FIG. 10, training data is built based on travel record data. The travel record data is time-series detection-device data obtained through detection by the plurality of detectors during traveling under different vehicle-load conditions. The detected values from the plurality of detectors for various points of time in the travel record data are associated with a value indicative of a vehicle load (by way of example, high, intermediate and low). For example, a detected value detected during traveling on an uphill slope may be recorded where it is associated with the vehicle-load value indicative of “high”, a detected value detected during traveling on a level ground may be recorded where it is associated with the vehicle-load value indicative of “intermediate”, and a detected value detected during traveling on a downhill slope may be recorded where it is associated with the vehicle-load value indicative of “low”.

The dataset corresponding to one point in time (i.e., one time point of interest) in the training data contains time-of-interest detected values, past values and post-detected values and, in addition, a value indicative of vehicle load. A plurality of datasets of the training data include datasets including the vehicle load “high”, datasets including the vehicle load “intermediate” and datasets including the vehicle load “low”. In other words, the plurality of datasets of the training data include all the values for a plurality of phases of vehicle load.

During the machine learning for generating the vehicle-load prediction model M11, the time-of-interest detected values and past values in each dataset are data input to the model, and the value indicative of vehicle load in each dataset is used as a label (i.e., correct-answer data). This machine learning enables generating a vehicle-load prediction model that generates a value indicative of vehicle load based on currently detected values and past values.

During the machine learning for generating the travel prediction model M12-1, the value indicative of vehicle load, time-of-interest detected values and past values in each dataset are used as data to be input to the model, and post-detected values in each dataset is used as labels (i.e., correct-answer data). This machine learning enables generating a travel prediction model M12-1 that generates a predicted value based on vehicle load and currently detected values and past values from the various detectors.

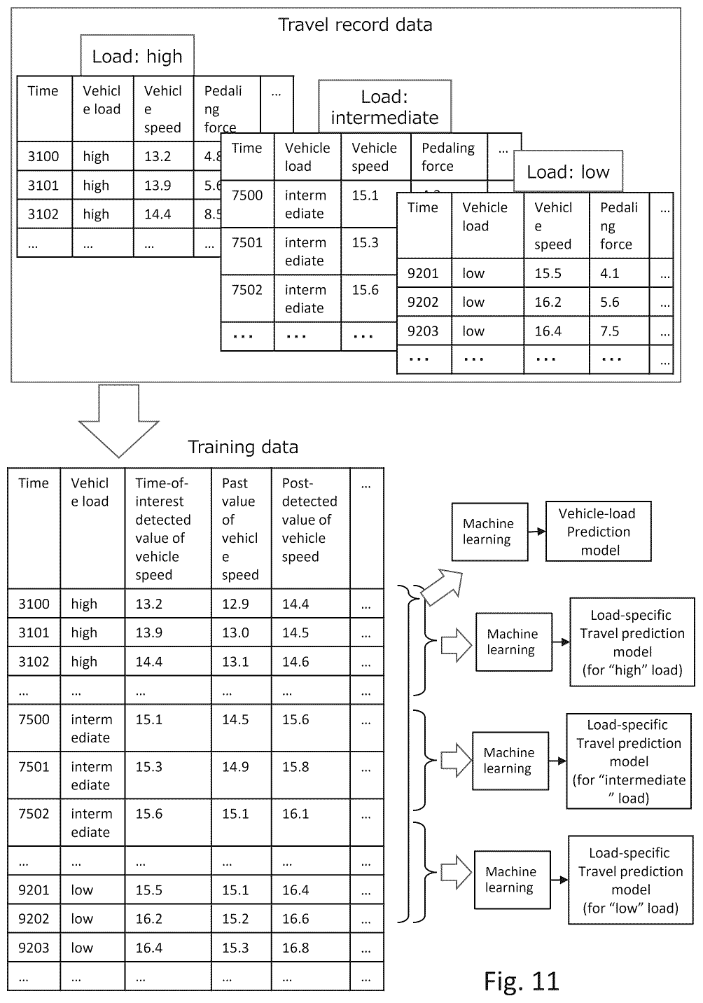

FIG. 11 illustrates an exemplary process for

generating the vehicle-load prediction model M11 and travel prediction model M12-2 shown in FIG. 7. In FIG. 11, the configuration of the travel record data and training data may be the same as in the implementation of FIG. 10. Further, the machine learning for generating a vehicle-load prediction model may be the same as in the implementation of FIG. 10. During the machine learning for generating a travel prediction model, each load-specific travel prediction model is generated through machine learning using a group of datasets of training data that have the same vehicle load level. In such an implementation, during the machine learning of each load-specific travel prediction model, time-of-interest detected values and past values from the various detectors in the dataset are data to be input to the model, and post-detected values are used as labels (i.e., correct-answer data). In the implementation of FIG. 11, a load-specific travel prediction model for a “high” vehicle load is generated through machine learning using the group of datasets for a “high” vehicle load. Similarly, a load-specific travel prediction model for an “intermediate” vehicle load is generated through machine learning using a group of datasets for an “intermediate” vehicle load, and a load-specific travel prediction model for a “low” vehicle load is generated through machine learning using a group of dataset for a “low” vehicle load.

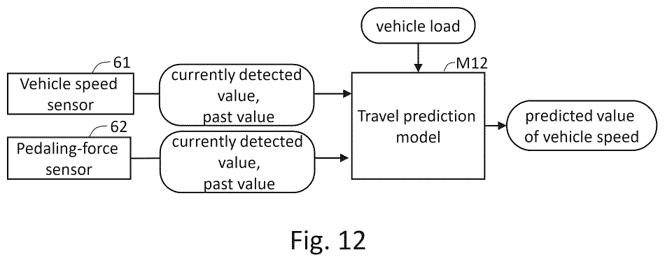

The prediction system may be configured such that the detected-value acquisition unit acquires currently detected values and past values from the vehicle speed sensor and pedaling-force sensor on the human-powered vehicle and the prediction unit outputs a predicted value of vehicle speed based on those values. This will enable making a prediction of vehicle speed that reflects the intention of the rider using a simple configuration. As used herein, vehicle speed is the velocity of the human-powered vehicle along the direction of forward travel. In such implementations, by way of example, the prediction unit may determine the value of vehicle load using the vehicle-load prediction model and based on currently detected values and past values of vehicle speed and pedaling force, and generate a predicted value of vehicle speed using the travel prediction model and based on the currently detected values and past values of vehicle speed and pedaling force as well as the determined value of vehicle load. FIG. 12 illustrates an exemplary travel prediction model M12 that generates a predicted value representing vehicle speed. The travel prediction model M12 in FIG. 12 receives, as input, currently detected values and past values from the vehicle speed sensor and pedaling-force sensor as well as a vehicle load, and provides a predicted value of vehicle speed as output.

The prediction system may be configured such that the detected-value acquisition unit acquires currently detected values and past values from the vehicle speed sensor, pedaling-force sensor and crank rotation sensor (e.g., cadence sensor) on the human-powered vehicle and the prediction unit outputs a predicted value of the number of crank rotations (e.g., cadence) based on those values. This will enable making a prediction of the number of crank rotations that reflects the intention of the rider using a simple configuration. In such implementations, by way of example, the prediction unit may determine the value of vehicle load using the vehicle-load prediction model and based on currently detected values and past values of vehicle speed, pedaling force and the number of crank rotations, and generate a predicted value of the number of crank rotations using the travel prediction model and based on the currently detected values and past values of vehicle speed, pedaling force and the number of crank rotations as well as the determined value of vehicle load. It will be understood that the detected-value acquisition unit may further acquire a currently detected value and a past value of the output of the motor for pedaling assistance. The prediction unit may generate a predicted value of the number of crank rotations also based on the currently detected value and the past value of motor output.

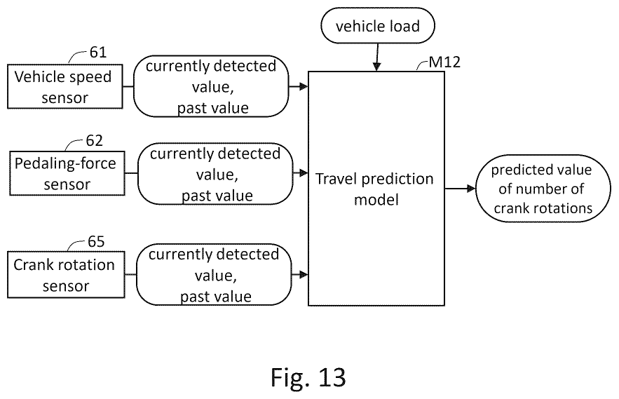

FIG. 13 illustrates an exemplary travel prediction model M12 that generates a predicted value representing the number of crank rotations. The travel prediction model M12 in FIG. 13 receives, as input, currently detected values and past values from the vehicle speed sensor, pedaling-force sensor and crank rotation sensor as well as a vehicle load, and provides a predicted value of the number of crank rotations as output. In the implementation of FIG. 13, the data to be input to the travel prediction model M12 may further include a currently detected value and a past value from the motor output sensor.

The prediction system may be configured such that the detected-value acquisition unit acquires currently detected values and past values from the vehicle speed sensor and pedaling-force sensor on the human-powered vehicle and the prediction unit outputs a predicted value of pedaling force based on those values. This will enable making a prediction of pedaling force that reflects the intention of the rider using a simple configuration. In such implementations, by way of example, the prediction unit may determine the value of vehicle load using the vehicle-load prediction model and based on currently detected values and past values of vehicle speed and pedaling force, and generate a predicted value of pedaling force using the travel prediction model and based on the currently detected values and past values of vehicle speed and pedaling force as well as the determined value of vehicle load. It will be understood that the detected-value acquisition unit may further acquire a currently detected value, or a currently detected value and past value, from the crank rotation sensor. The prediction unit may generate a predicted value of pedaling force also based on the currently detected value, or the currently detected value and past value, of the number of crank rotations.

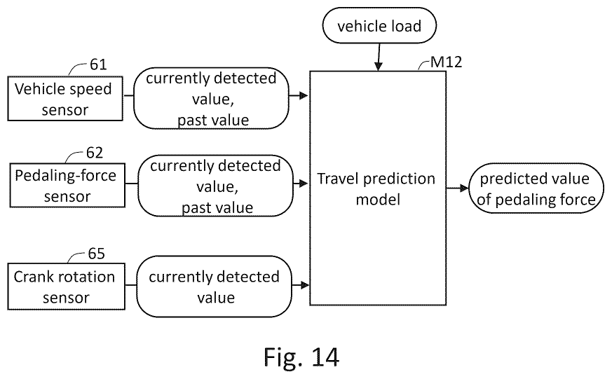

FIG. 14 illustrates an exemplary travel prediction model M12 that generates a predicted value representing pedaling force. The travel prediction model M12 in FIG. 14 receives, as input, currently detected values and past values from the vehicle speed sensor and pedaling sensor, a currently detected value from the crank rotation sensor, and a vehicle load, and provides a predicted value of pedaling force as output. Starting from the implementation of FIG. 14, the input of a currently detected value from the crank rotation sensor may be omitted. Further, starting from the implementation of FIG. 14, a past value from the crank rotation sensor may be added to the data to be input to the travel prediction model M12.

The prediction system may be configured such that the detected-value acquisition unit acquires currently detected values and past values from the vehicle speed sensor, the pedaling-force sensor and the motor output sensor for pedaling assistance on the human-powered vehicle, and the prediction unit outputs a predicted value of motor output based on those values. This will enable making a prediction of motor output for pedaling assistance that reflects the intention of the rider using a simple configuration. In such implementations, by way of example, the prediction unit may determine the value of vehicle load using the vehicle-load prediction model and based on currently detected values and past values of vehicle speed and pedaling force, and generate a predicted value of motor output using the travel prediction model and based on the currently detected values and past values of vehicle speed, pedaling force and motor output as well as the determined value of vehicle load. The detected-value acquisition unit may further acquire a currently detected value, or a currently detected value and past value, from the crank rotation sensor. The prediction unit may generate a predicted value of motor output also based on the currently detected value, or the currently detected value and past value, of the number of crank rotations.

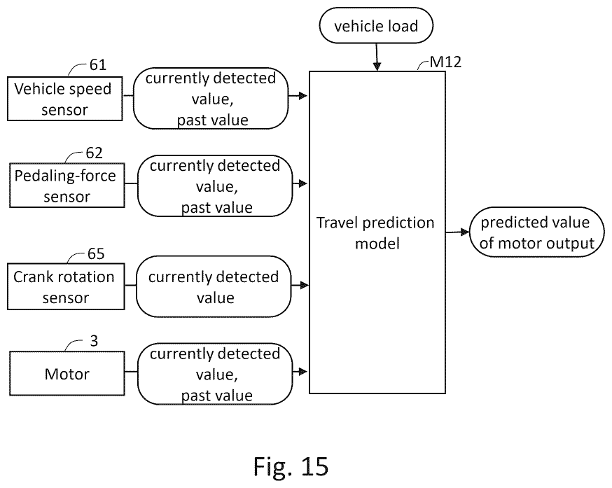

FIG. 15 illustrates an exemplary travel prediction model M12 that generates a predicted value representing motor output. The travel prediction model M12 in FIG. 15 receives, as input, currently detected values and past values from the vehicle speed sensor, pedaling-force sensor and motor output sensor, a currently detected values from the crank rotation sensor, and a vehicle load, and provides a predicted value of motor output as output. Starting from the implementation of FIG. 15, the input of a currently detected value from the crank rotation sensor may be omitted. Further, starting from the implementation of FIG. 15, a past value from the crank rotation sensor may be added to the data to be input to the travel prediction model M12.

In the implementations shown in FIGS. 12 to 15, the predicted value generated by the prediction unit is a prediction of a value being detected by one of the plurality of detectors that supply currently detected values to be acquired by the detected-value acquisition unit. In other words, the travel prediction model M12 generates a prediction of one of the currently detected values being input. This will enable more precise prediction. It will be understood that the travel prediction models in FIGS. 12 and 15 may have the configuration shown in FIG. 6 or 7. Further, the travel prediction model M12 may be a trained model without input of a vehicle load.

The predicted values are not limited to the above-discussed examples. For example, a predicted value may represent acceleration, the angle or angular velocity of at least one of roll, pitch or yaw of the human-powered vehicle, or whether there is a turn (i.e., curve).

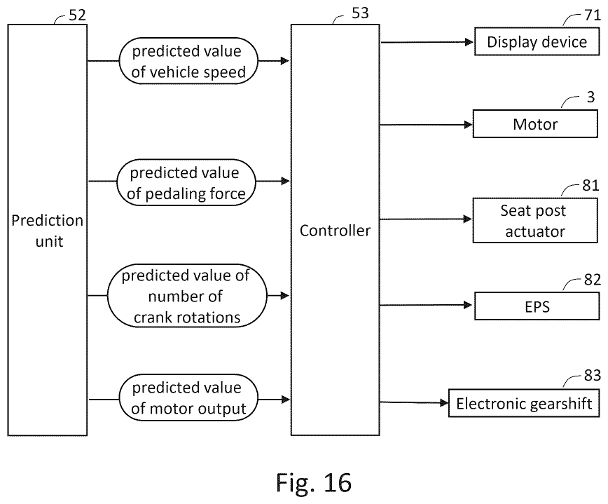

FIG. 16 is a functional block diagram illustrating an exemplary configuration of the controller 53 of the control system 5. As shown in FIG. 16, the controller 53 is able to control devices in the human-powered vehicle (i.e., bicycle) based on at least one of a predicted value of vehicle speed, a predicted value of pedaling force, a predicted value of the number of crank rotations, or a predicted value of motor output. In the implementation of FIG. 16, a device controlled by the controller 53 is at least one of the display device 71, motor 3, seat post actuator 81, electric power steering (EPS) 82, and electronic gearshift 83.

The controller 53 is able to control the motor output for pedaling assistance based on a predicted value of at least one of vehicle speed, pedaling force, the number of crank rotations, or motor output. For example, the amount of assistance by the motor 3 may be controlled based on the predicted value of pedaling force.

The control of the motor output for assistance by the controller 53 may be, for example, changes to the waveform of assisting force depending on the amount of assistance by the motor or pedaling force, or control of the magnitude of assisting force relative to pedaling force (i.e., assistance ratio), of the responsiveness of changes to the assisting force in response to changes in pedaling force, of assist mode, of the upper limit of assisting force, or other assist conditions.

The controller 53 may control the motor output for assistance based on two or more of a predicted value of vehicle speed, a predicted value of pedaling force, a predicted value of the number of crank rotations, or a predicted value of motor output. Controlling motor output using a combination of two or more predicted values will enable assistance in accordance with the intention of the rider in various situations. For example, the prediction unit 52 may output predictions of detected values from two or more of the plurality of detectors 6a and 6b. The controller 53 may be configured or programmed to control devices on the human-powered vehicle (e.g., motor for pedaling assistance) using predictions of detected values from two or more of the plurality of detectors 61 and 6b.

The controller 53 may be configured or programmed to perform a control to increase the amount of assistance by the motor for pedaling force when the predicted value indicates an increase in vehicle speed, i.e., acceleration. The controller may perform a control to reduce the amount of assistance by the motor for pedaling force when the predicted value indicates a decrease in vehicle speed, i.e., deceleration. The control of the amount of assistance for pedaling force may be, for example, control of the ratio of the assisting force by the motor for pedaling force (i.e., assistance ratio) or of the response speed of motor output to changes in pedaling force. Whether the predicted value indicates an increase or a decrease in vehicle speed may be determined by a comparison between the predicted value and currently detected value. For example, the predicted value may be determined to indicate an increase in vehicle speed if the predicted value of vehicle speed is larger than the currently detected value and the difference exceeds a threshold.

The controller may perform a control to increase the amount of assistance by the motor for pedaling force when the predicted value indicates an increase in pedaling force. This will improve the ability of the motor output to follow the intention of the rider of increasing pedaling force. For example, assistance will be possible with reduced delay from the beginning of an uphill slope. Further, when the predicted value indicates a decrease in pedaling force, the controller 53 may be configured or programmed to perform a control to reduce the amount of assistance by the motor 3, i.e., weaken the assistance.

The controller 53 may be configured or programmed to perform a control to reduce the amount of assistance by the motor for pedaling force when the predicted value indicates a decrease in vehicle speed, a decrease in pedaling force and a decrease in the number of crank rotations. This will reduce the rider's feel of remaining assistance when the vehicle is going to halt or decelerate, for example.

The controller 53 may be configured or programmed to perform a control to increase the amount of assistance by the motor for pedaling force when the predicted value indicates a decrease in vehicle speed, a decrease in the number of crank rotations and an increase in pedaling force. This will reduce a speed loss when the vehicle is climbing a slope, for example.

The controller 53 may be configured or programmed to perform a control to increase the amount of assistance by the motor for pedaling force when the predicted value indicates an increase in vehicle speed and an increase in the number of crank rotations and if the pedaling force is lower than a threshold. This will reduce a delay in assistance or a rapid rise in assistance when the vehicle has been halted and the rider begins to pedal, for example. By way of example, the controller 53 may loosen pedaling-related conditions for the motor initiating assistance when the predicted value indicates an increase in vehicle speed and an increase in the number of crank rotations. For example, the threshold of pedaling force that constitutes a condition for initiation of assistance may be lowered. This will enable initiating assistance for a low pedaling force when increases in vehicle speed and the number of crank rotations are predicted.

The controller 53 may be configured or programmed to perform a control to smoothen a rise in the motor's assistance for pedaling force when the predicted value indicates that vehicle speed is not changing. This will make it easier for the rider to travel at constant speed. The controller 53 may smoothen a rise in the motor's assistance for pedaling force by, for example, reducing the response speed of motor output to changes in pedaling force. Whether the predicted value indicates that vehicle speed is not changing may be determined by whether the difference between the currently detected value and predicted value of vehicle speed is within a predetermined range, for example.

The controller 53 may determine that a slip has occurred when the difference between the predicted values of vehicle speed, the number of crank rotations and pedaling force and their actually detected values exceed predetermined ranges, and perform a control to reduce the amount of assistance by the motor. This will make it possible to address a slip. Controlling motor output based on the difference between a predicted value and an actually detected value will enable assistance in a manner that addresses changes in situations, such as a slip.

The controller 53 may be configured or programmed to perform a control to lower the seat when the predicted value indicates that the amount of decrease in vehicle speed is not less than a threshold. The control unit may perform a control to raise the seat when the seat has been lowered and the predicted value indicates an increase in vehicle speed. For example, the controller 53 may lower the seat when the predicted value of vehicle speed indicates a decrease in speed to below a predetermined speed (e.g., 5 km/h). The position of the seat may be automatically changed by controlling the actuator 81 on the seat post, for example. Controlling the position of the seat depending on the predicted value of vehicle speed will enable adjusting the position of the seat depending on the intention of the rider.

The seat post is mounted on the seat frame portion (i.e., seat tube) 14. The seat 24 is mounted on the seat post. The seat post is constructed to adjust the height of the seat 24 relative to the road surface as the length of its portion protruding from the seat frame portion 14 is changed. The seat post includes an actuator 81. The actuator 81 may include an electric motor or solenoid. As the actuator 81 is driven, the seat post moves relative to the seat frame portion 14. The seat post may be a dropper seat post or adjustable seat post, for example.

If the predicted value indicates that pedaling force is not less than a threshold, the controller 53 may control the electric power steering (EPS) to keep travel straight. For example, if a strong pedaling force is predicted, the EPS may output a reactive force against the steering force input by the rider to make it easier for the rider to keep travel straight. Further, the controller may control the EPS to provide a quicker response of assistance to an input of steering if the predicted value indicates that the amount of decrease in vehicle speed is not less than a threshold. For example, if the predicted value predicts low-speed travel of the bicycle, the response speed of the EPS to an input of steering by the rider may be increased. This will enable smooth turning of the bicycle. The EPS may include a motor and a transmission mechanism that transmits rotation of the motor to the steering shaft. Further, the EPS may include a steering torque sensor that detects the steering torque input by the rider. The EPS is electrically connected to the control system 5 via a cable or wirelessly.

When the predicted value indicates an increase in the number of crank rotations, the controller 53 may control the electronic gearshift to perform an up-shift gear change, i.e., such a gear change that the pedaling will feel heavier. When the predicted value indicates a decrease in the number of crank rotations and an increase in pedaling force, the controller may control the electronic gearshift to perform a down-shift gear change, i.e., such a gear change that the pedaling will feel lighter. By way of example, if the prediction unit 52 predicts that cadence will increase, the controller 53 may cause the electronic gearshift to shift up; when the prediction unit 52 predicts that cadence will decrease and pedaling force will increase, the controller may cause the electronic gearshift to shift down. This will enable maintaining a situation that allows easy pedaling for the rider. The electronic gearshift may include a gear, a motor, and a gear-change sensor. The electronic gearshift is electrically connected to the control system 5 via a cable or wirelessly.

In addition to or in lieu of such control of the electronic gearshift, the controller 53 may display gearshift instructions on the display device. The controller 53 may be configured or programmed to perform a control to temporarily stop assistance by the motor 3 upon a gearshift operation by the rider or upon a gear change by the electronic gearshift.

The human-powered vehicle according to example embodiments of the present invention may be an electric motor-assisted bicycle or, for example, an electric bicycle or electrically driven motorcycle with pedals (i.e., electric moped). Further, the human-powered vehicle is not limited to two-wheeled vehicles, and may be a vehicle with three or more wheels.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A system for predicting travel of a human-powered vehicle, the system comprising:
at least one computer configured or programmed to function as:
a detected-value acquisition unit to acquire currently detected values at a current point in time from a plurality of detectors on the human-powered vehicle and past values based on values detected by the plurality of detectors prior to the current point in time; and
a prediction unit to generate a predicted value relating to the travel of the human-powered vehicle using a trained model built through machine learning and based on the currently detected values and the past values from the plurality of detectors acquired by the detected-value acquisition unit.

2. The system according to claim 1, wherein
the plurality of detectors include at least two of a vehicle speed sensor, a pedaling-force sensor, a crank rotation sensor, an acceleration sensor, or a motor output sensor; and
the predicted value generated by the prediction unit includes a value indicative of at least one of a vehicle speed, a pedaling force, a number of crank rotations, an acceleration, or a motor output.

3. The system according to claim 1, wherein the detected-value acquisition unit is configured or programmed to acquire, as the past values from the plurality of detectors, past values based on a group of values detected in a period of time prior to the current point in time.

4. The system according to claim 1, wherein
the trained model includes a vehicle-load prediction model and a travel prediction model; and
the prediction unit includes:
a vehicle-load determination unit to determine a value indicative of a vehicle load on the human-powered vehicle using the vehicle-load prediction model and based on currently detected values and past values from at least two of the plurality of detectors; and
a travel prediction unit to generate the predicted value using the travel prediction model and based on the value indicative of the vehicle load and the currently detected values and the past values from the plurality of detectors.

5. The system according to claim 4, wherein
the travel prediction model includes a plurality of load-specific travel prediction models corresponding to a plurality of vehicle load levels; and
the travel prediction unit is configured or programmed to generate the predicted value using a load-specific travel prediction model corresponding to the value indicative of the vehicle load determined by the vehicle-load determination unit.

6. The system according to claim 4, wherein the travel prediction model is a trained model configured to receive, as input, the value indicative of the vehicle load and the currently detected values and the past values from the plurality of detectors and provide, as output, the predicted value relating to the travel of the human-powered vehicle.

7. A system for controlling a human-powered vehicle comprising:
the system for predicting the travel of the human-powered vehicle according to claim 1; and
a controller configured or programmed to control a device on the human-powered vehicle based on the predicted value generated by the prediction unit.

8. The system according to claim 7, wherein the device is at least one of a motor configured to assist a rider in human-powered driving, a motor configured to assist the rider in steering, an actuator configured to adjust a position of a seat on which the rider sits, an electronic gearshift, or a display.

9. A non-transitory storage medium storing a trained-model program built through machine learning, the trained-model program configured to receive, as input, currently detected values at a current point in time from a plurality of detectors on a human-powered vehicle and past values based on values detected by the plurality of detectors prior to the current point in time, and provide, as output, a predicted value relating to travel of the human-powered vehicle.

10. The non-transitory storage medium according to claim 9, wherein the trained-model program includes:
a vehicle-load prediction model configured to receive, as input, currently detected values and past values from at least two of the plurality of detectors and provide, as output, a value indicative of a vehicle load on the human-powered vehicle; and
a travel prediction model configured to receive, as input, the value indicative of the vehicle load output by the vehicle-load prediction model and the currently detected values and the past values from the plurality of detectors, and provide the predicted value as output.

11. A system for generating a model for predicting travel of a human-powered vehicle, the system comprising:
at least one computer configured or programmed to function as:
a training-data acquisition unit to acquire, as training data, a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest;
a machine learning unit to generate, through machine learning using the training data, a trained model to provide, as output, a predicted value relating to future travel of the human-powered vehicle after the current point in time based on currently detected values at a current point in time and past values based on values detected prior to the current point in time from the plurality of detectors.

12. The system according to claim 11, wherein
the training-data acquisition unit is configured or programmed to acquire the plurality of datasets each further including a value indicative of a vehicle load on the human-powered vehicle; and
the machine learning unit is configured or programmed to generate the trained model to provide the predicted value as output based on, in addition to the currently detected values for the current point in time and the past values from the plurality of detectors, the value indicative of the vehicle load.

13. The system according to claim 1, wherein
the at least one computer includes a vehicle-mountable computer and a vehicle-mountable storage to be mounted on the human-powered vehicle;
the vehicle-mountable computer is configured or programmed to perform the functions of the detected-value acquisition unit and the prediction unit; and
the vehicle-mountable storage is configured to store the trained model to be used for the functions of the prediction unit.

14. A non-transitory storage medium storing a program for predicting travel of a human-powered vehicle, the program to cause a computer to perform:
a detected-value acquisition process in which currently detected values at a current point in time from a plurality of detectors on the human-powered vehicle and past values based on values detected by the plurality of detectors prior to the current point in time are acquired; and
a prediction process in which a predicted value relating to the travel of the human-powered vehicle is generated using a trained model built through machine learning and based on the currently detected values and the past values from the plurality of detectors acquired in the detected-value acquisition process.

15. A method of predicting travel of a human-powered vehicle performed by a computer, the method comprising:
acquiring detected-values in which currently detected values at a current point in time from a plurality of detectors on the human-powered vehicle and past values based on values detected by the plurality of detectors prior to the current point in time; and
generating a predicted a value relating to the travel of the human-powered vehicle using a trained model built through machine learning and based on the currently detected values and the past values from the plurality of detectors acquired in the step of acquiring detected-values.

16. A non-transitory storage medium storing a program for generating a model for predicting travel of a human-powered vehicle, the program being executable to cause a computer to perform:
a training-data acquisition process in which a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest from the plurality of detectors are acquired as training data; and
a machine learning process in which a trained model is generated through machine learning using the training data, the trained model configured to receive, as input, currently detected values at a current point in time from the plurality of detectors and past values based on values detected by the plurality of detectors prior to the current point in time, and provide, as output, a predicted value relating to future travel of the human-powered vehicle after the current point in time.

17. A method of generating a model for predicting travel of a human-powered vehicle performed by a computer, the method comprising:
acquiring training-data in which a plurality of datasets each including time-of-interest detected values for a time point of interest from a plurality of detectors on the human-powered vehicle, past values based on values detected by the plurality of detectors prior to the time point of interest, and post-detected values for a point in time after the time point of interest from the plurality of detectors are acquired as training data; and
machine learning a trained model generated using the training data, the trained model configured to receive, as input, currently detected values at a current point in time from the plurality of detectors and past values based on values detected by the plurality of detectors prior to the current point in time, and provide, as output, a predicted value relating to future travel of the human-powered vehicle after the current point in time.
